(19) United States
(12) Patent Application Publication
(10) Pub. No.: US 2015/0222531 A1
(43) Pub. Date: Aug. 6, 2015

(54) Prefix-based Entropy Detection in MPLS Label Stacks

(71) Applicant: BROADCOM CORPORATION, IRVINE, CA (US)

(72) Inventors: Rupa Budhia, San Jose, CA (US); Puneet Agarwal, Cupertino, CA (US)

(73) Assignee: BROADCOM CORPORATION, IRVINE, CA (US)

(21) Appl. No.: 14/259,230

(22) Filed: Apr. 23, 2014

Related U.S. Application Data
(60) Provisional application No. 61/934,900, filed on Feb. 3, 2014.

(51) Int. Cl. H04L 12/723; H04L 12/781

(52) U.S. Cl. CPC H04L 45/507; H04L 45/52

(57) ABSTRACT

A system and method is provided for creating and detecting prefix-based entropy labels in a multi-protocol label switching communication network. Each label in a label stack is provided with at least a common prefix field and a computed hash field without the use of entropy label indicators (ELIs). Label stacks generated are processed by transit LSRs in an MPLS communications network where the transit LSR uses the first N labels of the label stack to determine the hash computations for load balancing. By scattering prefix-based entropy labels throughout the label stack, the transit LSR uses one or more prefix-based entropy labels for the hash computation.

### CROSS REFERENCE TO RELATED APPLICATIONS/INCORPORATION BY REFERENCE

The present U.S. Utility Patent Application claims priority pursuant to 35 U.S.C. §119(e) to U.S. Provisional Application No. 61/934,900, entitled “Prefix-Based Entropy Detection in MPLS Label Stacks,” filed Feb. 03, 2014, which is hereby incorporated herein by reference in its entirety and made part of the present U.S. Utility Patent Application for all purposes.

### BACKGROUND

1. Technical Field

The present disclosure described herein relates generally communication networks and more particularly to load balancing in a communication network.

2. Description of Related Art

Communication systems are known to support wireless and wireline communications between wireless and/or wireline communication devices. Such communication systems range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, 3GPP (3rd Generation Partnership Project), 4GPP (4th Generation Partnership Project), LTE (long term evolution), LTE Advanced, RFID, IEEE 802.11, Bluetooth, AMPS (advanced mobile phone services), digital AMPS, GSM (global system for mobile communications), CDMA (code division multiple access), LMDS (local multi-point distribution systems), MMDS (multi-channel-multi-point distribution systems), and/or variations thereof.

As communication networks evolve, the data processing requirements are becoming larger and larger. Data traffic is typically transmitted and received through communication nodes. For example, in a multiprotocol label switching (MPLS) communications network, nodes are used between the data provider and the data recipient to create communication paths until the data is received by the recipient. Data providers use data load balancing techniques in an attempt to balance data traffic between communication paths from the data provider to the recipient evenly, ensuring efficient network traffic capacity. Typically, each node in the communication network selects some fields from the data packet headers that delineate a flow for the data traffic. These fields are an input to a load balancing function (e.g., cyclic redundancy check (CRC), XOR (e.g., source MAC address XOR'd with destination MAC address, etc.) to select a path for that data traffic.

### BRIEF DESCRIPTION OF THE DRAWING(S)

FIG. 1 illustrates an example embodiment of a multiprotocol label switching (MPLS) communications network in accordance with the present disclosure;

FIG. 2 illustrates an example embodiment of a data traffic flow path in an MPLS communications network in accordance with the present disclosure;

FIG. 3 illustrates an example embodiment of an entropy label for the label stack of a data packet in an MPLS communications network in accordance with the present disclosure;

FIG. 4 illustrates an example embodiment of a data packet in a MPLS communications network in accordance with the present disclosure;

FIG. 5 illustrates a flow diagram for an example embodiment for generating prefix-based entropy labels in a MPLS communications network in accordance with the present disclosure; and

FIG. 6 illustrates an example embodiment flow diagram for label stack creation and usage in accordance with the present disclosure.

### DETAILED DESCRIPTION

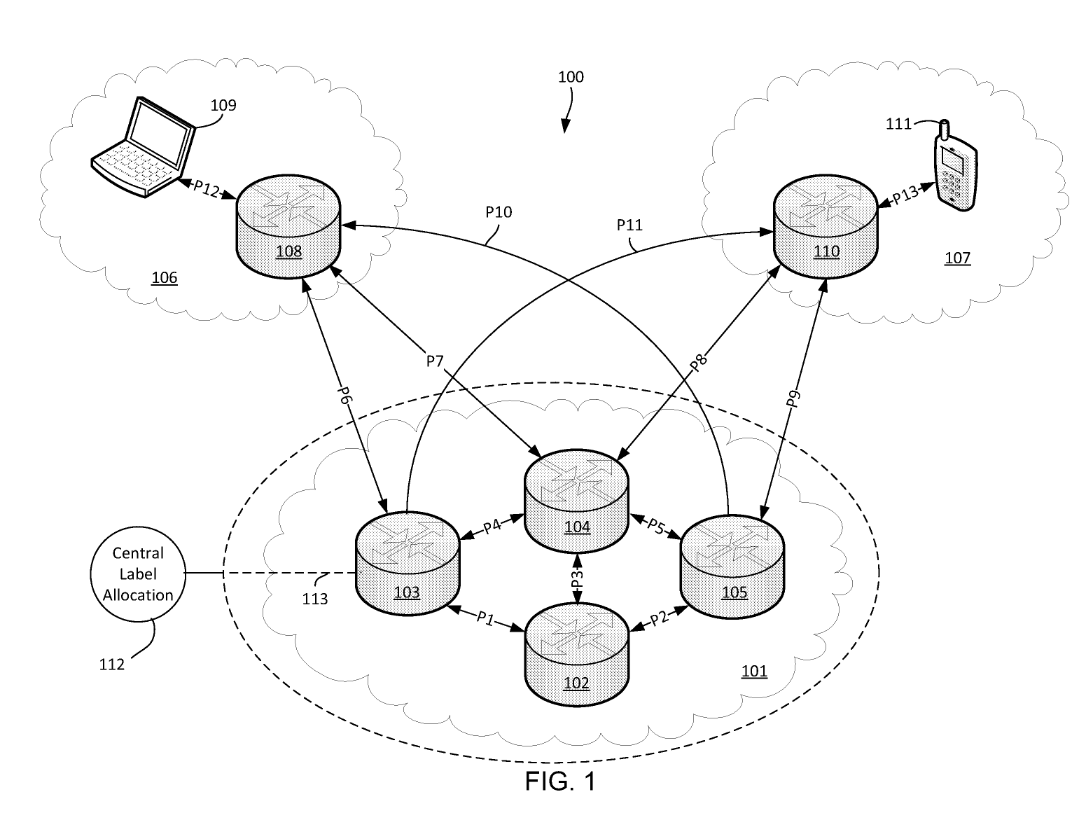

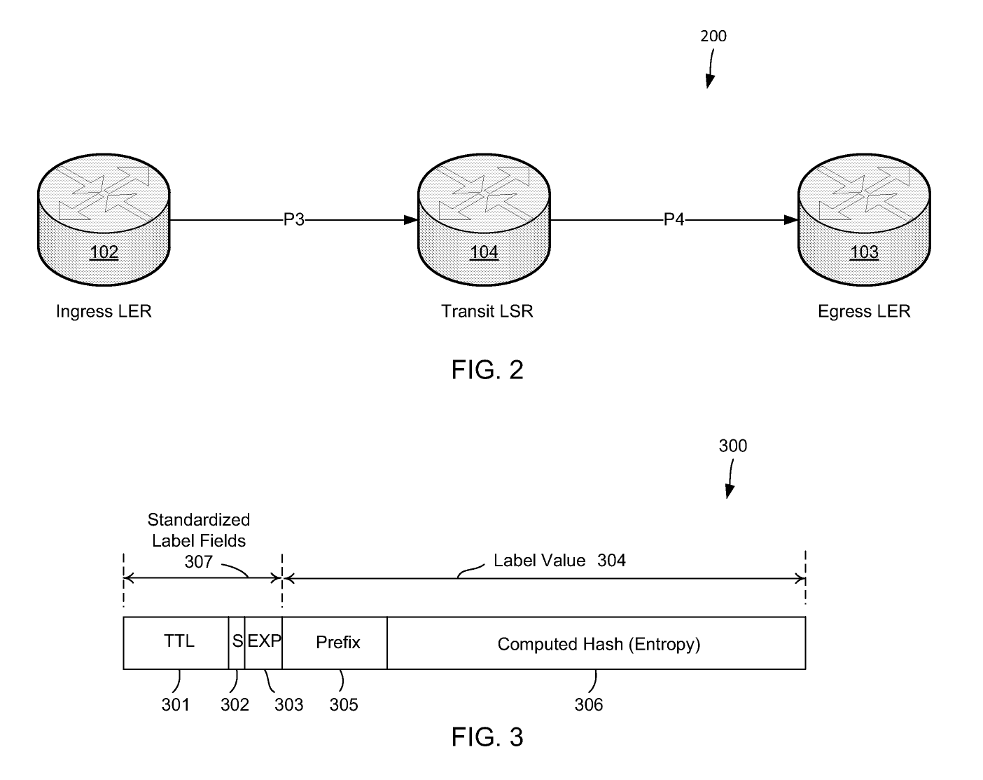

FIG. 1 illustrates an example embodiment of a multiprotocol label switching (MPLS) communications network in accordance with the present disclosure. Communications network 100 includes multiprotocol label switching (MPLS) communications network 101 (e.g., a data center) having a series of label controlled routers, such as label edge routers (LERs—ingress/egress) and label switching routers (LSR) supporting different data traffic flow paths. Multiprotocol label switching (MPLS) communications network 101 includes routers, which can serve various functions depending where they are in the data traffic flow path. For example, data originates at an ingress router, is passed to various transit routers along the data traffic flow paths and ends at an egress router. Labels are provided 113 to an ingress router within MPLS network 101 by, for example, a Central Label Allocation (CLA) 112, which acts as a central administrator for entropy labels and will be described in greater detail hereafter within FIG. 2 description, et al.

In a first example embodiment, a user location 106 with electronic communications device (e.g., laptop 109) transmits, starting with path P12, a request for data from a data center. The data stored on computer based storage devices (e.g., servers with hard drives within a server farm) originates from ingress router 102, is passed through label switched path P2 to transit router 105, and then through label switched path P5 to transit router 104 and through label switched path P4 to egress router 103 where it is transmitted over path P6 to final destination router 108 within the user's home location or other a public/private communications network communicating with a mobile electronic communication device. Communications external to the Multiprotocol label switching (MPLS) communications network (e.g., P6) can use a variety of known or future transmission protocols, not to exclude MPLS.

Mobile electronic communication devices include, for example, personal computers, laptops, PDAs, smartphones, mobile phones, such as cellular telephones, devices equipped with wireless local area network or Bluetooth transceivers, digital cameras, digital camcorders, wireless printers, or other devices that either produce, process or use audio, video signals or other data or communications.

In a second example embodiment, a user location 107 with mobile communications device 111 (e.g., smartphone, tablet, etc.) requests data starting with path P13 from a data center. As in the first example embodiment, the data originates from ingress router 102. However, in this example embodiment, the data is passed through label switched path P3 to transit router 104 and then through label switched path P5 to egress router 105 and transmitted over path P9 to final destination router 110 within the user's home location. As before, communications external to the Multiprotocol label switching (MPLS) communications network (e.g., P9) can use a variety of known or future transmission protocols, not to exclude MPLS.

In MPLS networks, data traffic flow is directed between network nodes (routers) using short label paths rather than long network addresses. The short label paths are dictated by label stacks attached to the data packets in a data traffic flow and determine the path from the beginning router (ingress router) to the destination egress router (terminal router at the end of the transmission). While not explicitly described in the above example embodiments, any of a number of paths such as P1, P7, P8, P10 and P11 can be chosen during path selection and load balancing. The descriptions of the present disclosure are not limited by specific topology, routers or paths.

In typical MPLS networks, the initial communication is provided by an ingress label switch router (LSR) where the payload is visible. The ingress LSR (router which first prefixes the MPLS header to a data packet) computes a hash of the data packet and places it in an entropy label. An entropy label is an extra label in the label stack that is not used as a forwarding label or signaling label. The entropy label functions to provide load balancing information in the label stack.

Ingress LSR 102 has detailed knowledge of the data packet contents allowing for specific payload parsing procedures to compute entropy labels for specific protocols. For example, an ingress LSR knows the expected data packet encapsulation is a specific transport payload such as IPv4 (internet protocol version 4), IPv6 (internet protocol version 6), ATM (asynchronous transfer mode), Frame Relay, etc. and bases the entropy label on that protocol. Having the payload parsing procedures already identified by the ingress LSR, transit LSR(s) downstream of the ingress LSR do not need any information on the data packet payload contents and therefore do not need to repeat the payload parsing functionality of the ingress LSR and simply use the Entropy label to perform hashing for load balancing.

In known MPLS networks, the entropy label's presence in the label stack is indicated by an entropy label indicator (ELI) that is pushed in the stack before the entropy label. Intermediate network nodes (i.e., transit label switching routers (LSR)) between the ingress LER and the terminal node use the first N labels of the label stack for hashing. Therefore, multiple label pairs (ELI+entropy) are scattered throughout the label stack ensuring that LSRs with different values of N are able to include entropy (i.e., a number of specific ways in which a data path may be arranged) in their hash for effective load balancing.

FIG. 2 illustrates an example embodiment of a data traffic flow path in an MPLS communications network in accordance with the present disclosure. Data traffic flow path 200 includes ingress LER 102 communicating data traffic to egress LER 103. Ingress LER 102 communicates data traffic through path P3 to transit LSR 104. The data traffic is processed by transit LSR 104 according to the label stack and communicated to egress LER 103 through path P4. In alternative embodiments, transit LSR 103 includes N (N>1) transit LSRs for communicating the data traffic to egress LER 103.

In one embodiment, a MPLS communications network connects a high-capacity data center having a high degree of multi-pathing (multiple potential data traffic flow paths). In order for the MPLS communications network to operate at capacity, entropy labels are used to balance the data traffic load over the transit LSRs. In a deep MPLS label stack, entropy labels are present in multiple places as transit LSR(s) use the first N incoming labels for hashing. Traditionally, entropy labels are identified by the transit LSR(s) using an entropy label indicator (ELI), a 2 bit indicator signifying the presence of a subsequent entropy label. However, as entropy labels are added to the label stack, the depth of the label stack increases by one ELI label for each entropy label, increasing the complexity for communicating the data traffic. For example, parsing and editing (i.e., push/pop/skip label, etc.) the label stack becomes more difficult as each additional ELI and entropy label is added to the label stack. For another example, transit LSR(s) typically pop (dispose) two labels, each including both the ELI and the entropy value, and therefore the use of ELI labels increases the number of labels to be popped by two before the packet is forwarded to the next node in the data traffic flow path.

In one embodiment of the technology described herein, an MPLS communications network eliminates the use of ELIs. In this embodiment, a set of label values that share a common prefix are designated as entropy labels, thus eliminating the need to add ELIs to the entropy labels. The entropy label prefix lengths and values are determined either by a Common Label Allocation (CLA) entity, a network administrator or by nodes in the network reaching an agreement on the prefix via a control protocol. For example, the entropy label prefix lengths and values are determined by a CLA entity in connection with an ingress LSR (e.g., shown as optional connection 113 in FIG. 1) where entropy label values are created by concatenating the common prefix and computed hash value. While shown connected to LSR 103, the CLA provides labels with common prefixes to any ingress LSR/LER where the data path begins. Also, the CLA can, in one embodiment, be added to any MPLS network (e.g., all LSRs/LERs within an MPLS network allocated entropy labels by, for example, a CLA or group of CLAs). As long as nodes within a MPLS communication network agree on a common prefix, they can recognize entropy labels without the use of ELIs.

FIG. 3 illustrates an example embodiment of an entropy label for the label stack of a data packet in an MPLS communications network in accordance with the present disclosure. In the example embodiment, entropy label 300 includes standardized label fields 307 including, but not limited to, time to live (TTL) field 301, bottom of stack field “S” 302 and an experiment (EXP) field 303. The label value fields 304 include prefix field 305 and computed hash field 306. However, it is understood by those skilled in the art that the entropy label is not limited to the fields shown in FIG. 3.

Time to live field 301, S field 302 and EXP field 303 are standardized fields for the beginning of the entropy label. Time to live field 301 limits the lifespan or lifetime of a data packet in a communications network. In one embodiment, TTL field 301 is implemented as a counter or timestamp attached to or embedded in the entropy label and prevents a data packet from circulating through the network indefinitely. S field 302 is used to signify that the current entropy label is the last label in the label stack. S field 302 is followed by experiment (EXP) field 303, providing quality of service (QoS) and explicit congestion notification (ECN) information concerning the subsequent data packet. Other known or future standardized fields can be substituted without departing from the scope of the present disclosure.

The label value portion 304 of entropy label 300 includes, in the MSBs (most significant bits), a prefix. As previously discussed, labels are allocated throughout the MPLS communications network including a common prefix field 305. The length and value of common prefix field 305 is assigned, for example, by the CLA entity. The LSBs (least significant bits) of the entropy label include computed hash field 306 that is computed by the ingress LSR. The ingress LSR computes the load-balancing information in the form of a hash function, selecting the path for the data packets in a given data traffic flow. Computed hash field 306 is computed based on data packet types including, but not limited to, internet protocol source and destination addresses, protocol type and the source and destination port numbers. Ingress LSR concatenates common prefix field 305 and computed hash field 306 for the completed entropy label.

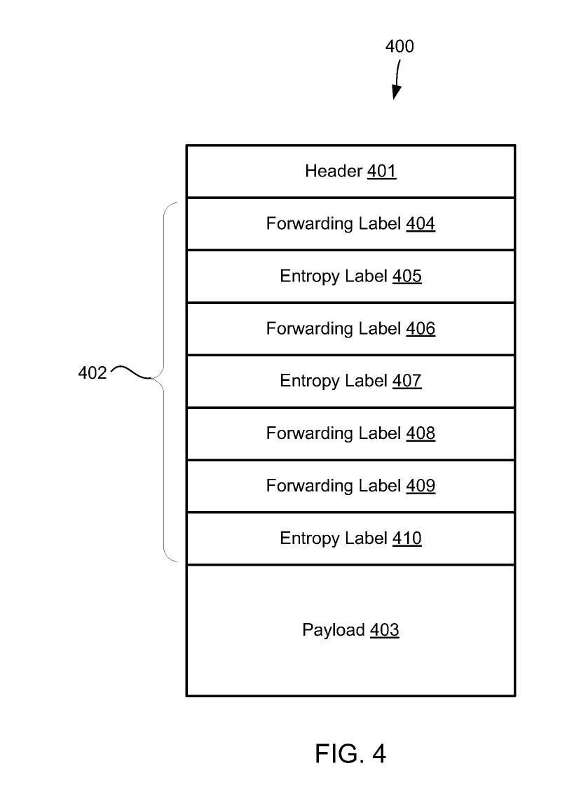

FIG. 4 illustrates an example embodiment of a data packet in an MPLS communications network in accordance with the present disclosure. Data packet 400 includes header 401, label stack 402 and payload 403. Label stack 402 includes entropy labels 405, 407 and 410 scattered (distributed, for example, after a forwarding label) between forwarding labels 404, 406, 408 and 409. Although shown in FIG. 4 as a specific sequence (i.e., forwarding label 404, entropy label 405, forwarding label 406, entropy label 407, forwarding label 408, forwarding label 409, entropy label 410), it is understood that other sequences are possible without departing from the scope of the present disclosure. In one embodiment, the entropy values of the entropy labels in the label stack are unique in relation to each other.

Each entropy label in the label stack is provided with at least a prefix field and a computed hash field as described in FIG. 3. As previously discussed, typically entropy labels would include an ELI to signify the next entropy label in the label stack. The technology described herein eliminates the use of ELIs from the entropy stack, replacing the function of the ELI with the common prefix field. Label stacks generated according to the present disclosure are processed by transit LSRs in an MPLS communications network where in the transit LSR uses the first N labels of the label stack to determine the hash computations for load balancing. By scattering entropy labels throughout the label stack, as shown in FIG. 4, the transit LSR uses one or more entropy labels for the hash computation. Traditional label stacks that use ELIs require the use of more labels for hash computation in order to ensure that one or more entropy labels are included in the computation. In one embodiment, the presence of an entropy label in a label stack is detected through prefix matching against the known common prefix allocated by, for example, the CLA for the MPLS network. In a default action by transit LSRs, entropy labels exposed at the transit LSR are popped. By removing ELIs from the entropy labels of label stacks, the number of entropy labels parsed (and popped) at transmit LSRs is smaller than label stacks that include ELIs for entropy stacks.

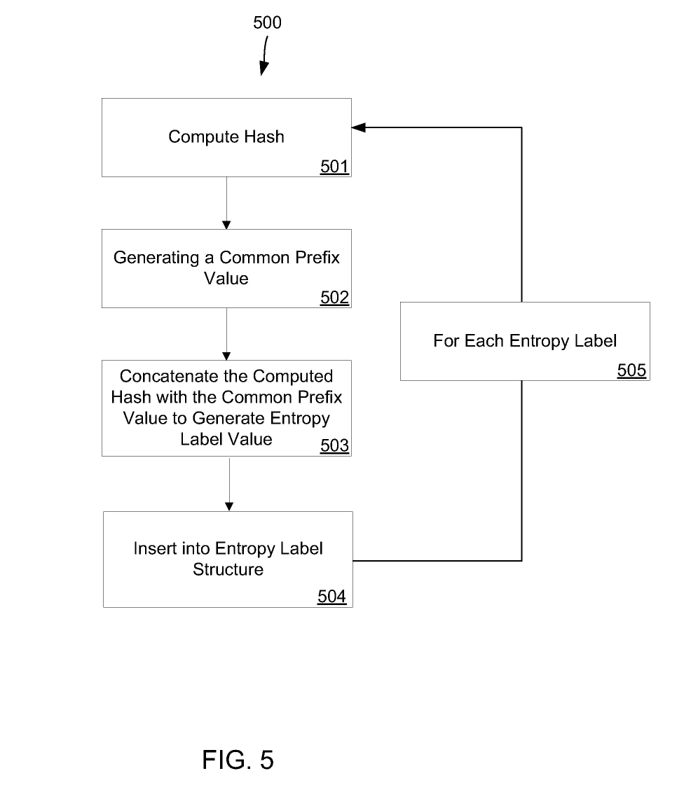

FIG. 5 illustrates a flow diagram 500 for an example embodiment for the process of generating prefix-based entropy labels in a MPLS communications network in accordance with the present disclosure. In step 501, a hash value (306) is computed for the entropy label(s). In step 502, the value (and length thereof) of the common prefix field (305) is determined/generated (e.g., via CLA, network administration or control protocol entity). In step 503, the ingress LSR concatenates the common prefix value (305) with the computed hash value (306) to create the entropy label value (304), which is inserted into an entropy label structure in step 504 (e.g., including other standardized label fields (307)). The steps are repeated in step 505 for each entropy label created.

In one embodiment, the common prefix field is shared for the entropy labels in a label stack. In another embodiment, the common prefix field is shared between label stacks of data packets from corresponding data traffic flows to ensure that the same data traffic flow path is maintained for each data packet flow. Maintaining the data traffic flow path for each data packet of a data traffic flow avoids jitter, latency and reordering issues in downstream communications.

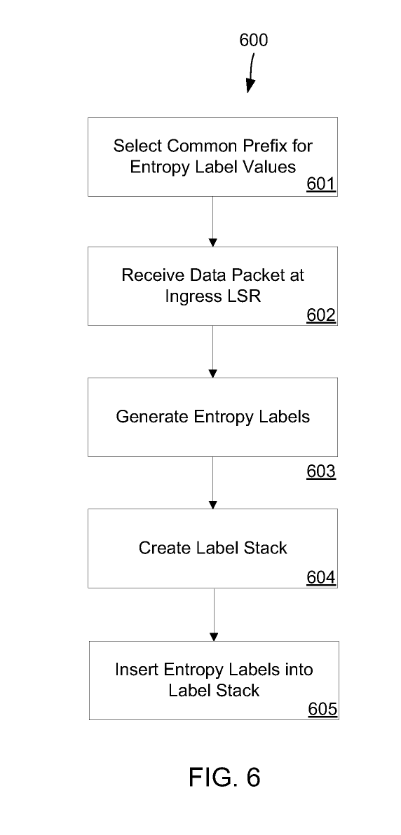

FIG. 6 illustrates an example embodiment flow diagram 600 for label stack creation and usage in accordance with the present disclosure. In step 601, a common prefix for entropy label values is selected (e.g., agreed upon by all nodes in the network via a CLA, a network administration or a control protocol). In step 602, data packets arrive at ingress LSR. In step 603, the ingress LSR generates the entropy Labels as per FIG. 5. In step 604, the label stack is created (e.g., as shown in FIG. 4). In step 605, the generated entropy labels are distributed across the label stack for forwarding. The data packets, complete with appropriate label stacks, are communicated, for example, to downstream transit LSR(s) for further processing, e.g., computing a hash value from at least a subset N of the plurality of entropy labels for load balancing and forwarding. This further processing is repeated for all interceding path nodes until the data packet is ultimately communicated to the terminal node (egress LSR) in the data traffic flow path.

The technology described herein provides for methodology for implementing entropy in a communication networks by parsing a smaller number of entropy labels, eliminating the skipping over of ELIs during hash computations and simplifying data packet editing due to a fewer number of entropy labels that are popped by the transit LSR(s).

As may be used herein, the terms “substantially” and “approximately” provide an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments of an invention have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The one or more embodiments are used herein to illustrate one or more aspects, one or more features, one or more concepts, and/or one or more examples of the invention. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module includes a processing module, a processor, a functional block, hardware, and/or memory that stores operational instructions for performing one or more functions as may be described herein. Note that, if the module is implemented via hardware, the hardware may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure of an invention is not limited by the particular examples disclosed herein and expressly incorporates these other combinations.

1. A method for a multiprotocol label switching (MPLS) network, the method comprising:
computing a hash value from a data packet to be communicated across the MPLS network;
generating a common prefix value for labels to be communicated across the MPLS network;
generating an entropy label value by concatenating the computed hash value with the generated common prefix value; and
generating an MPLS network entropy label by inserting the generated entropy label value into an entropy label structure.

2. The method according to claim 1, wherein the hash value is computed by an ingress router within the multiprotocol label switching (MPLS) network.

3. The method according to claim 1, wherein the common prefix value is common to nodes within the MPLS network.

4. The method according to claim 1, wherein generating the common prefix value includes a central label allocation (CLA) entity allocating the common prefix value.

5. The method according to claim 1, wherein generating the common prefix value includes receiving the common prefix value from a network administrator.

6. The method according to claim 1, wherein generating the common prefix value includes nodes in the MPLS network reaching an agreement on the common prefix value via a control protocol.

7. The method according to claim 1, wherein the concatenating includes placing the common prefix value in most significant bits (MSBs) of the entropy label value and the computed hash value in least significant bits (LSBs) of the entropy label value.

8. The method according to claim 1 further comprising distributing the generated MPLS network entropy labels across a label stack.

9. The method according to claim 8, wherein the label stack is inserted into at least one data packet for forwarding within the MPLS network.

10. The method according to claim 8 further comprising a transit label switched router (LSR) within the MPLS network hashing one or more of the MPLS network entropy labels for load balancing.

11. The method according to claim 1, further comprising identifying one or more of the MPLS network entropy labels via prefix matching against the common prefix value.

12. A method for a multiprotocol label switching (MPLS) network, the method comprising:
selecting a common prefix for MPLS entropy label values;
receiving a data packet at an ingress router;
generating MPLS entropy labels including the selected common prefix;
creating a label stack for the received data packet; and
inserting the generated MPLS entropy labels into the created label stack.

13. The method according to claim 12, wherein the selected common prefix is common to nodes within the MPLS network.

14. The method according to claim 12, wherein the selecting a common prefix value includes any of: a central label allocation (CLA) entity allocating the common prefix, receiving the common prefix from a network administrator, and nodes in the MPLS network reaching an agreement on the common prefix via a control protocol.

15. The method according to claim 12 further comprising a transit label switched router (LSR) within the MPLS network hashing one or more of the generated MPLS entropy labels for load balancing.

16. The method according to claim 12 further comprising identifying one or more of the generated MPLS entropy labels within the label stack via prefix matching against the common prefix.

17. A multi-protocol label switching (MPLS) communications network comprising:
an ingress router configured to:
receive data packets;
compute a hash of the received data packets;
receive a common prefix for labels to be communicated within the MPLS communications network;
generate MPLS entropy labels with at least the common prefix and the computed hash;
generate a label stack including the generated MPLS entropy labels for routing the data packets; and
forward the data packets through selected data traffic flow paths within the MPLS communications network based on the generated label stack.

18. The multi-protocol label switching (MPLS) communications network according to claim 17 further comprising at least one transit label switch router (LSR) communicatively coupled to the ingress router and configured to load balance data traffic flow through the selected data traffic flow paths as determined by the hash of one or more of the generated MPLS entropy labels within the label stack associated with at least one data packet.

19. The multi-protocol label switching (MPLS) communications network according to claim 18 further comprising the at least one transit label switch router (LSR) further configured to identify one or more of the generated MPLS entropy labels within the label stack via prefix matching against the common prefix.

20. The multi-protocol label switching (MPLS) communications network according to claim 17, wherein a plurality of the MPLS entropy labels are distributed across the label stack.
